(19) United States
(12) Patent Application Publication
(10) Pub. No.: US 2016/0372127 A1
(43) Pub. Date: Dec. 22, 2016

(54) RANDOM NOISE SEED VALUE GENERATION

(71) Applicant: QUALCOMM Incorporated, San Diego, CA (US)

(72) Inventors: Venkata Subrahmanyam Chandra Sekhar Chebiyyam, San Diego, CA (US); Vivek Rajendran, San Diego, CA (US); Venkatraman S. Atti, San Diego, CA (US); Subasingha Shaminda Subasingha, San Diego, CA (US)

(21) Appl. No.: 14/836,689

(22) Filed: Aug. 26, 2015

Related U.S. Application Data
(60) Provisional application No. 62/183,140, filed on Jun. 22, 2015.

(51) Int. Cl. G10L 19/12; G10L 19/028; G10L 19/083; G10L 19/002; G10L 19/018; G06F 3/16

(52) U.S. Cl. CPC G10L 19/12; G10L 19/018; G06F 3/165; G10L 19/083; G10L 19/002; G10L 19/028

(57) ABSTRACT

A method includes selecting, at a device, a first seed generation scheme or a second seed generation scheme based on determining whether audio data satisfies a criterion. The audio data corresponds to a first audio frame of a sequence of frames. The first seed generation scheme includes generating a first seed value based on one or more parameters corresponding to the first audio frame (e.g., the bit-stream indices). The second seed generation scheme includes generating a second seed value based on a seed output value associated with a second audio frame of the sequence of frames. A seed value generated by the selected seed generation scheme is provided to a random noise generator.

### I. CROSS-REFERENCE TO RELATED APPLICATION(S)

The present application claims priority from U.S. Provisional Patent Application No. 62/183,140 entitled “RANDOM NOISE SEED VALUE GENERATION,” filed Jun. 22, 2015, the contents of which are incorporated by reference in their entirety.

### II. FIELD

The present disclosure is generally related to generating random noise associated with an audio frame.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, may communicate voice and data packets over wireless networks. Further, many such wireless telephones include other types of devices that are incorporated therein. For example, a wireless telephone may also include a digital still camera, a digital video camera, a digital recorder, and an audio file player. Also, such wireless telephones may process executable instructions, including software applications, such as a web browser application, that may be used to access the Internet. As such, these wireless telephones may include significant computing capabilities.

Electronic devices, such as wireless telephones, may use wideband coding techniques involve encoding and transmitting a low frequency portion of an input audio signal (e.g., 50 Hertz (Hz) to 7 kilohertz (kHz), also called the “low-band”). In order to improve coding efficiency, a higher frequency portion of the input audio signal (e.g., 7 kHz to 16 kHz, also called the “high-band”) may not be fully encoded and transmitted. For example, a transmitting device may generate a first synthesized audio signal based on the input audio signal and a noise signal. The transmitting device may generate high-band parameter information based on a comparison of the first synthesized audio signal and the input audio signal. The transmitting device may transmit a low-band excitation signal, low-band parameter information, and the high-band parameter information to the receiving device. The receiving device may use the low-band excitation signal, the low-band parameter information, the high-band parameter information, and a second noise signal to generate a second synthesized audio signal. If the second noise signal is distinct from the noise signal, the second synthesized audio signal may differ from the input audio signal.

### IV. SUMMARY

In a particular aspect, a method includes selecting, at a device, a first seed generation scheme or a second seed generation scheme based on determining whether audio data satisfies a criterion. The audio data corresponds to a first audio frame of a sequence of frames. The first seed generation scheme includes generating a first seed value based on a bit-stream parameter corresponding to the first audio frame. The second seed generation scheme includes generating a second seed value based on a seed output value associated with a second audio frame of the sequence of frames. The method also includes providing, at the device, a seed value to a random noise generator, wherein the seed value is generated by the selected seed generation scheme.

In another aspect, a device includes a plurality of seed generators, a processor, and a memory. The processor is configured to select a particular seed generator of the plurality of seed generators based on determining whether audio data satisfies a criterion. The processor is also configured to provide a seed value to a random noise generator. The seed value is generated by the particular seed generator. The memory is configured to store the seed value.

In another aspect, a computer-readable storage device stores instructions that, when executed by a processor, cause the processor to perform operations including selecting a particular seed generator of a plurality of seed generators based on determining whether audio data satisfies a criterion. The operations also include providing a seed value to a random noise generator. The seed value is generated by the particular seed generator. The operations further include generating a synthesized high-band excitation signal based on a noise signal. The noise signal is generated by the random noise generator based on the seed value.

Other aspects, advantages, and features of the present disclosure will become apparent after review of the application, including the following sections: Brief Description of the Drawings, Detailed Description, and the Claims.

### V. BRIEF DESCRIPTION OF THE DRAWINGS

FIG. 1 is a block diagram of a particular illustrative example of a system that includes devices operable to select between multiple seed generation schemes for a random noise generator;

FIG. 2 is a diagram illustrating a particular example of audio signal encoding components that may be included in one or more devices of the system of FIG. 1;

FIG. 3 is a diagram illustrating a particular example of audio signal decoding components that may be included in one or more devices of the system of FIG. 1;

FIGS. 4A-D are diagrams illustrating particular examples of seed values that may be generated by seed generators of the devices of FIG. 1 for several example sequences of audio frames;

FIG. 5 is a diagram illustrating examples of spectrograms of decoded speech that is generated based on a mismatched seed and that is generated based on a matching seed;

FIG. 6 is a diagram illustrating examples of histograms of seed values generated according to different seed generation schemes that may be used by one or more devices of the system of FIG. 1;

FIG. 7 is a flow chart illustrating a particular method of generating a seed value;

FIG. 8 is a flow chart illustrating another particular method of generating a seed value;

FIG. 9 is a flow chart illustrating yet another particular method of generating a seed value; and

FIG. 10 is a block diagram of a particular illustrative example of a device that is operable to select between multiple seed generation schemes.

### VI. DETAILED DESCRIPTION

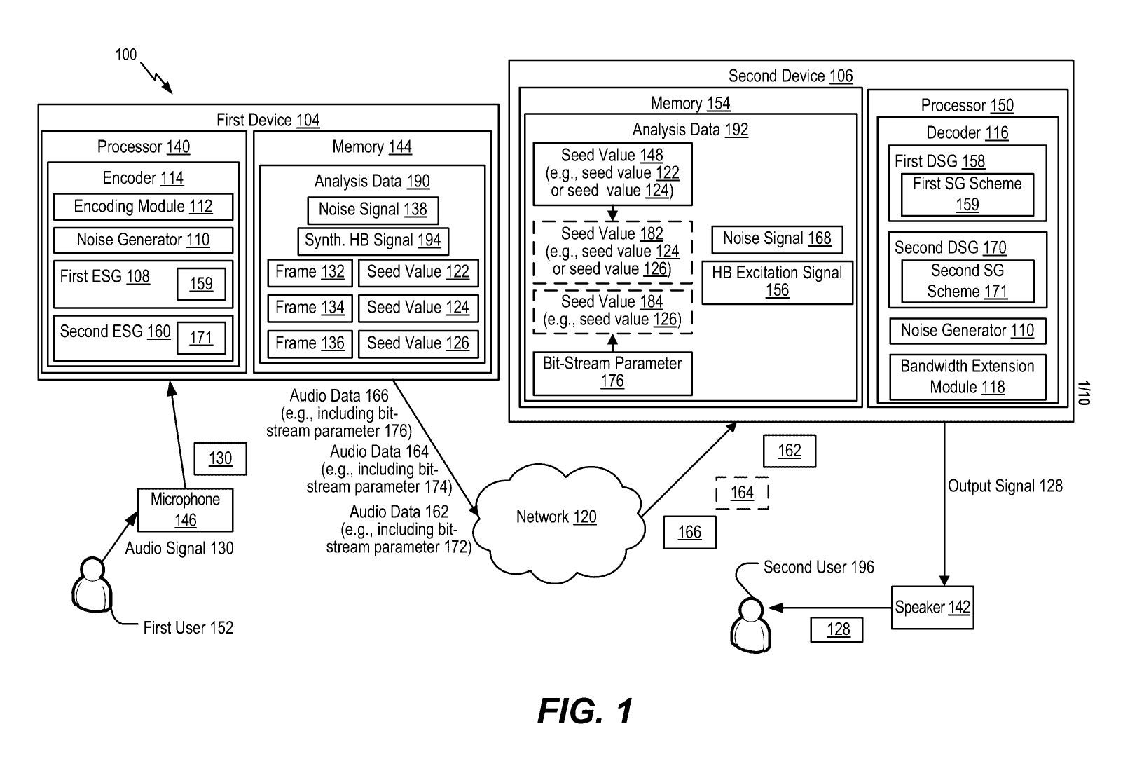

Referring to FIG. 1, a particular illustrative example of a system that includes a first device 104 and a second device 106 that are operable to select between multiple seed generation schemes is disclosed and generally designated 100.

The first device 104 includes a processor 140 and a memory 144. The processor 140 includes an encoder 114 that includes a plurality of seed generators, such as a first encoder seed generator (ESG) 108 and a second encoder seed generator 160. The encoder 114 also includes an encoding module 112 and a noise generator 110 (e.g., a random noise generator). The noise generator 110 may include a random number generator. The memory 144 stores analysis data 190 that includes a noise signal 138, a first synthesized high-band signal 194 (e.g., a synthesized high-band signal), and a sequence of frames 132-136 and seed values 122-126 associated with respective frames of the sequence of frames 132-136. The first device 104 may be operated by a first user 152 and may receive an audio signal 130 via a microphone 146 (e.g., the first device 104 may include a mobile telephone).

The first device 104 may be communicatively coupled to the second device 106 via a network 120 that may include one or more wireless networks, one or more wired networks, or a combination thereof. The second device 106 includes a processor 150 and a memory 154. The processor 150 includes a decoder 116 that includes a plurality of seed generators, such as a first decoder seed generator (DSG) 158 and a second decoder seed generator 170. The decoder also includes a noise generator 110 and a bandwidth extension module 118. The memory 154 stores analysis data 192 that includes a noise signal 168, seed values 148, 182, and 184, and a bit-stream parameter 176. The second device 106 may be operated by a second user 196 and may receive an output signal 128 via a speaker 142 (e.g., the second device 106 may include a mobile telephone).

During operation, the first device 104 may receive the audio signal 130. The encoder 114 may divide the incoming audio signal 130 into a sequence of frames including a frame 132, a frame 134, and a frame 136. The encoding module 112 may process the frames 132-136. For example, the encoding module 112 may generate a first low-band signal and a first high-band signal corresponding to the frame 136. The encoding module 112 may generate first low-band parameters (e.g., the bit-stream parameter 176) and a first low-band excitation signal based on the first low-band signal. The bit-stream parameter 176 may include a line spectral frequencies (LSF) index, a low-band pitch index, a low-band fixed codebook excitation index, a pitch gain index, a fixed codebook excitation gain index, a high-band LSF index, or a combination thereof, as an illustrative, non-limiting example.

The first encoder seed generator 108 may be selected to generate a seed value 126 corresponding to the frame 136 according to a first seed generation scheme 159, such as based on at least a portion of the first bit-stream parameter 176. Although implementations are described in which the first seed generation scheme 159 is based on the bit-stream (e.g., the first bit-stream parameter 176), in other implementations the first seed generation scheme 159 may be configured to generate a seed value for a frame based on one or more frame parameters for the frame other than (or in addition to) the bit-stream. Alternatively, the second encoder seed generator 160 may be selected to generate the seed value 126 according to a second seed generation scheme 171, such as based on another seed value (e.g., a seed value 124 or a seed output value) associated with another frame (e.g., the frame 134) of a sequence of frames (e.g., frame 124 may precede frame 126 in a sequence of frames that includes frames 122, 124, and 126).

A noise generator 110 of the first device 104 may generate a noise signal 138 based on the seed value 126. The encoding module 112 may generate a first synthesized high-band signal 194 based on the first low-band excitation signal, the first low-band parameters, and the noise signal 138. The encoding module 112 may generate first high-band parameters based on a comparison of the first synthesized high-band signal 194 and the frame 136. The encoding module 112 may generate audio data 166, such a frame data, that includes the first low-band parameters (e.g., the bit-stream parameter 176), the first low-band excitation signal, and the first high-band parameters. The encoder 114 may send the audio data 166 to the second device 106.

A first decoder seed generator 158 of the second device 106 may be configured to determine the seed value 184 according to the first seed generation scheme 159, such as based on at least a portion of the bit-stream parameter 176. The seed value 184 may be the same as the seed value 126 determined by the first encoder seed generator 108 because the first decoder seed generator 158 uses the same bit-stream index (e.g., the bit-stream parameter 176) as the first encoder seed generator 108. Alternatively, a second decoder seed generator 170 may be configured to generate a seed value for the frame 136 according to the second seed generation scheme 171, such as based on another seed value (e.g., the seed value 124 or a seed output value) associated with another frame (e.g., the frame 134 of the sequence of frames that includes frames 122, 124, and 126), as described in further detail below.

A noise generator 110 of the second device 106 may generate a noise signal 168 based on the seed value 184. Using the same seed value, the noise generator 110 of the second device 106 may generate the same noise as the noise generator 110 of the first device 104 (e.g., the noise signal 168 matches the noise signal 138).

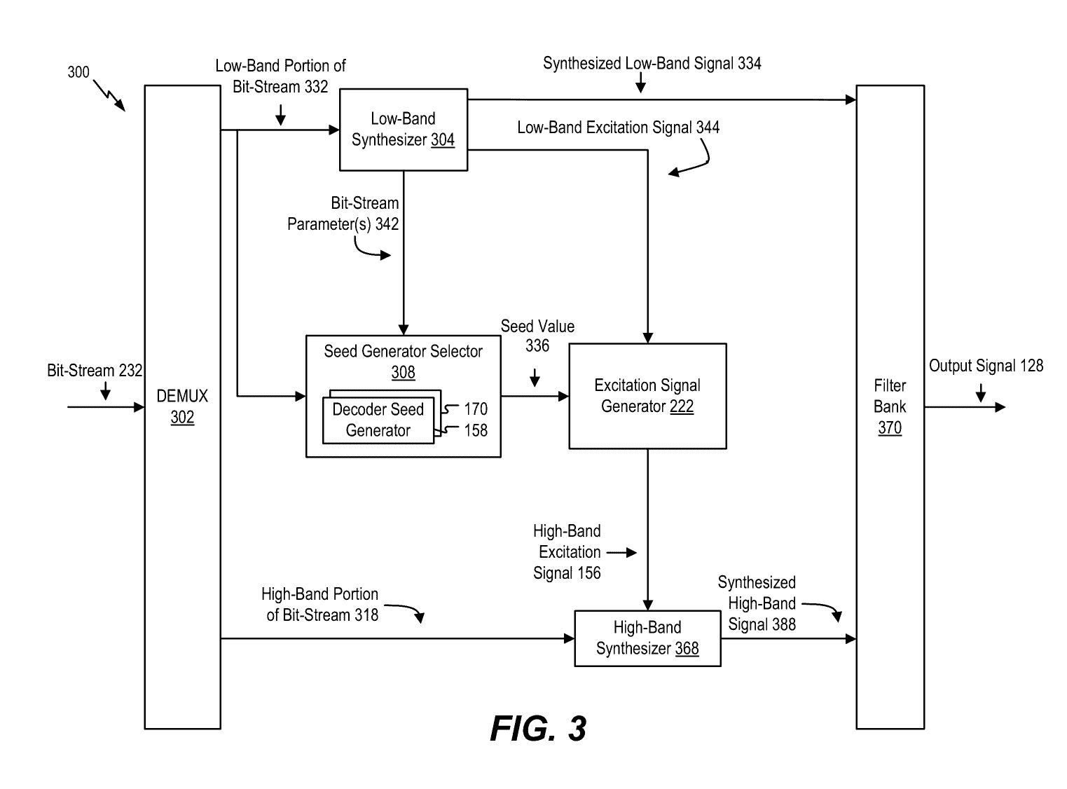

A bandwidth extension module 118 may generate an output signal 128 based on the first low-band excitation signal, the first low-band parameters, the first high-band parameters, and the noise signal 168. For example, the bandwidth extension module 118 may generate a high-band excitation signal 156 based on the first low-band excitation signal and the noise signal 168, as described with reference to FIG. 3. The bandwidth extension module 118 may send the output signal 128 to a speaker 142.

In a particular aspect, the processor 140 (or the processor 150) is configured to select a particular seed generator of the plurality of seed generators based on determining whether audio data satisfies a criterion, to provide the seed value that is generated by the particular seed generator to the noise generator 110, and to store the seed value in the memory 144 (or the memory 154).

The processor 140 (or the processor 150) may select the particular seed generator and may generate the seed value based on the following pseudo-code:

if(st−>last_extl != SWB_TBE && st−>extl == SWB_TBE)
/*Criterion met. Seed generation for current frame is based on LSF
Index*/
{

tmp1 = ((LSFIdx[0]<<4) + LSFIdx[1]); /*2\hat{ }4*LSFIdx[0] +
LSFIdx[1]*/
tmp = (tmp1 − ((tmp1 >> 7) << 7)); /*reminder with 128*/
tmp1 = tmp & 1;
tmp2 = tmp & 64;
tmp3 = LSFIdx[1] & 1;
tmp4 = LSFIdx[0] & 1;
bwe_seed = ( ( (tmp−tmp1−tmp2) + (tmp1<<6) ) + (tmp2>>6)
); /*flip bits*/
bwe_seed[0] = ( ( bwe_seed[0] − 63 ) >> 9); /*bring to full
range*/

}
else
{

/*Criterion not satisfied. Seed generation of current frame based

on seed of the previous frame. */

bwe_seed = bwe_seed + (bwe_seed%7)*2;

}

For example, the encoder 114 (or the decoder 116) may be configured to select the first encoder seed generator 108 (or the decoder seed generator 158) to determine the seed value 126 (or the seed value 184) of the frame 136 based on the bit-stream parameter 176. For example, the encoder 114 (or the decoder 116) may determine the seed value 126 (or the seed value 184) based on the bit-stream parameter 176 using the first encoder seed generator 108 (or the first decoder seed generator 158) in response to determining that the frame 136 satisfies a criterion. For example, the encoder 114, the decoder 116, or both, may determine that the frame 136 satisfies the criterion in response to determining that a pitch gain of the frame 136 satisfies a pitch gain threshold, a spectral tilt of the frame 136 satisfies a spectral tilt threshold, a voicing parameter of the frame 136 satisfies a voicing threshold, a first mode (e.g., a first encoding mode or a first decoding mode) is associated with the frame 136 and a second mode (e.g., a second encoding mode or a second decoding mode) is associated with another frame, the frame 136 corresponds to a first frame type (e.g., speech or active content) and the other frame corresponds to a second frame type (e.g., non-speech, music, or inactive content that includes audio content such as silence or background noise), a first coding mode (e.g., Time Domain Bandwidth Extension mode) is associated with the frame 136 and a second coding mode (any mode which is not Time Domain Bandwidth Extension mode, e.g., Frequency Domain Bandwidth Extension mode) is associated with the consecutively previous frame, meaning that a coding mode switch happens, a first coder (e.g., an algebraic code-excited linear prediction (ACELP) coder) was used to encode/decode the frame 136 and a second coder (e.g., a transform coded excitation (TCX) coder) was used to encode/decode the other frame, or a combination thereof.

At the first device 104, the other frame may correspond to the frame 134. The frame 134 may be a previous frame of the sequence of frames for which the first encoder seed generator 108 generated a seed value (e.g., the seed value 124). At the second device 106, the other frame may correspond to the frame 132 or the frame 134. For example, the other frame may correspond to the frame 134 when the second device 106 receives audio data 164 (e.g., frame data) corresponding to the frame 134. As another example, the other frame may correspond to the frame 132 when the second device 106 receives audio data 162 (e.g., frame data) corresponding to the frame 132 and does not receive the audio data 164. For example, the audio data 164 may be lost or delayed.

In a particular implementation, the encoder 114 (or the decoder 116) may select the second encoder seed generator 160 (or the second decoder seed generator 170) to determine the seed value 126 (or a seed value 182) based on a seed value of the other frame in response to determining that the frame 136 fails to satisfy the criterion. For example, the second encoder seed generator 160 may determine the seed value 126 according to the second seed generation scheme 171, such as based on the seed value 124 of frame 134, in response to determining that the frame 136 fails to satisfy the criterion. As another example, the second decoder seed generator 170 may determine a seed value 182 according to the second seed generation scheme 171, such as based on a seed value 148 (e.g., the seed value 122 or the seed value 124) of the other frame in response to determining that the frame 136 fails to satisfy the criterion. The seed value 182 may be the same as the seed value 126 when the second device 106 receives the audio data 164 and when the seed value 148 is the same as seed value 122. The seed value 182 may differ from the seed value 126 when the second device 106 receives the audio data 162 and does not receive the audio data 164. For example, the seed value 182 may be the same as the seed value 124 when the second device 106 generates the seed value 182 based on the audio data 162 (e.g., the seed value 122). In this implementation, the noise generator 110 of the second device 106 may generate the noise signal 168 based on the seed value 182.

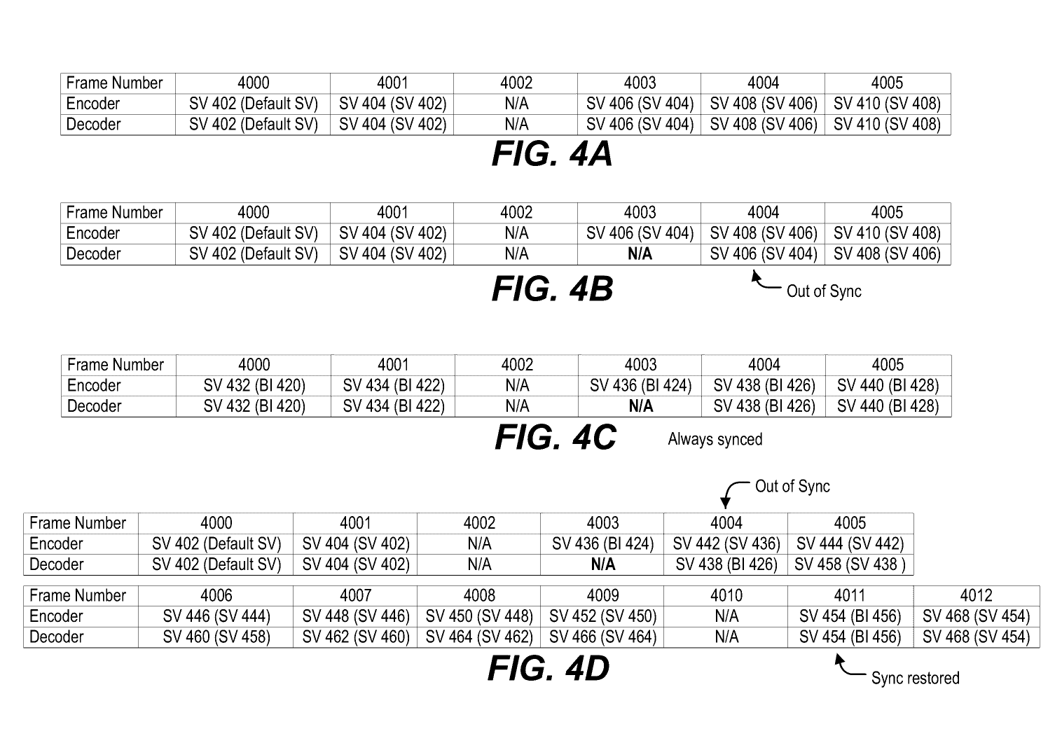

The encoder and the decoder using the same seed value is referred to as seed synchrony. Seed synchrony affects the quality of encoding/decoding schemes which depend on Analysis by Synthesis principles. Seed values that are generated based on previous seed values may have a flat distribution across a range of values but may permanently lose synchrony between the seed values at the encoder and the decoder after a frame erasure, as described in further detail with respect to FIG. 4B. Seed values that are generated based on bit-stream indices may provide a high confidence of seed synchrony in which the same seed values are generated at an encoder and a decoder. Because, even if the synchrony is lost for any particular frame due to a frame erasure at the decoder, the synchrony is restored as soon as a valid packet arrives at the decoder, as described in further detail with respect to FIG. 4C. However, in cases of stationary signals, the seed value is likely to be repetitive or constant which may lead to deviation from a very flat distribution across the range of possible seed values, which may not be desirable for a random seed. The system 100 may enable a balance between having a flat distribution and having the same seed value at the decoder and the encoder by generating a seed value of a frame based on a previous seed value when the frame fails to satisfy a criterion and generating the seed value based on a bit-stream index of the frame when the frame satisfies the criterion.

Although FIG. 1 depicts use of a noise seed that is based on a switched seed generation mechanism in an implementation that uses the noise seeds (e.g., the seed values 122-126) to generate the noise signals 138, 168 for high-band encoding and decoding, respectively, such use of the noise seeds to generate the noise signals 138, 168 for high-band encoding and decoding is for illustrative purposes only. In other implementations, the switched seed generation mechanism and the noise signals 138, 168 may be used for any purpose. For example, the disclosed seed generation schemes and selection between the seed generation schemes could be used to generate noise to be used in a Generic Audio Signal coding module for the Low-Band.

It should be noted that in the above description, various functions performed by the system 100 of FIG. 1 are described as being performed by certain components or modules. However, this division of components and modules is for illustration only. According to another implementation, a function performed by a particular component or module may instead be divided amongst multiple components or modules. Moreover, in another implementation, two or more components or modules of FIG. 1 may be integrated into a single component or module. Each component or module illustrated in FIG. 1 may be implemented using hardware (e.g., a field-programmable gate array (FPGA) device, an application-specific integrated circuit (ASIC), a central processing unit (CPU), a digital signal processor (DSP), a controller, etc.), software (e.g., instructions executable by a processor), or any combination thereof.

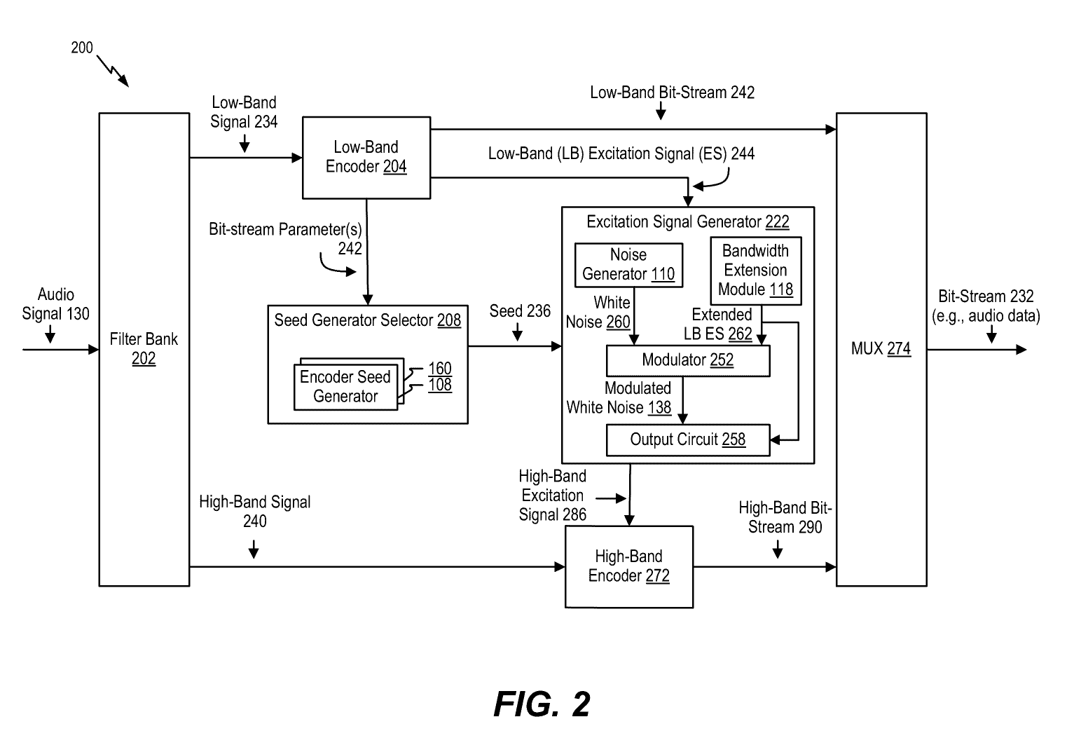

FIG. 2 is a diagram illustrating a particular example of audio signal encoding components that may be included in one or more devices of the system of FIG. 1, such as in the encoder 114 of the first device 104. The system 200 includes a filter bank 202, such as an analysis filter bank, that is configured to receive the audio signal 130. For example, the audio signal 130 may be provided by a microphone or other input device. According to one implementation, the audio signal 130 may include speech. The audio signal 130 may be a super wideband (SWB) signal that includes data in the frequency range from approximately 50 hertz (Hz) to approximately 16 kilohertz (kHz). The filter bank 202 may filter the audio signal 130 into multiple portions based on frequency. For example, the filter bank 202 may generate a low-band signal 234 and a high-band signal 240. The low-band signal 234 and the high-band signal 240 may have equal or unequal bandwidths, and may be overlapping or non-overlapping. According to another implementation, the filter bank 202 may generate more than two outputs.

In the example of FIG. 2, the low-band signal 234 and the high-band signal 240 occupy non-overlapping frequency bands. For example, the low-band signal 234 and the high-band signal 240 may occupy non-overlapping frequency bands of 50 Hz-7 kHz and 7 kHz-16 kHz, respectively. According to another implementation, the low-band signal 234 and the high-band signal 240 may occupy non-overlapping frequency bands of 50 Hz-8 kHz and 8 kHz-16 kHz, respectively. According to another implementation, the low-band signal 234 and the high-band signal 240 overlap (e.g., 50 Hz-8 kHz and 7 kHz-16 kHz), which may enable a low-pass filter and a high-pass filter of the filter bank 202 to have a smooth rolloff, which may simplify design and reduce cost of the low-pass filter and the high-pass filter. Overlapping the low-band signal 234 and the high-band signal 240 may also enable smooth blending of low-band and high-band signals at a receiver, which may result in fewer audible artifacts.

It should be noted that although the example of FIG. 2 illustrates processing of a SWB signal, this is for illustration only. According to another implementation, the audio signal 130 may be a wideband (WB) signal having a frequency range of approximately 50 Hz to approximately 8 kHz. In such an implementation, the low-band signal 234 may correspond to a frequency range of approximately 50 Hz to approximately 6.4 kHz, and the high-band signal 240 may correspond to a frequency range of approximately 6.4 kHz to approximately 8 kHz.

The system 200 may include a low-band encoder 204 configured to receive the low-band signal 234. According to one implementation, the low-band encoder 204 may represent a code excited linear prediction (CELP) encoder. The low-band encoder 204 may include a linear prediction (LP) analysis and coding module, a linear prediction coefficient (LPC) to line spectral pair (LSP) transform module, and a quantizer. LSPs may also be referred to as line spectral frequencies (LSFs), and the two terms may be used interchangeably herein. The LP analysis and coding module may encode a spectral envelope of the low-band signal 234 as a set of LPCs. LPCs may be generated for each frame of audio (e.g., 20 milliseconds (ms) of audio, corresponding to 320 samples at a sampling rate of 16 kHz), each sub-frame of audio (e.g., 5 ms of audio), or any combination thereof. The number of LPCs generated for each frame or sub-frame may be determined by the “order” of the LP analysis performed. According to one implementation, the LP analysis and coding module may generate a set of eleven LPCs corresponding to a tenth-order LP analysis.

The LPC to LSP transform module may transform the set of LPCs generated by the LP analysis and coding module into a corresponding set of LSPs (e.g., using a one-to-one transform). Alternately, the set of LPCs may be one-to-one transformed into a corresponding set of parcor coefficients, log-area-ratio values, immittance spectral pairs (ISPs), or immittance spectral frequencies (ISFs). The transform between the set of LPCs and the set of LSPs may be reversible without error.

The quantizer may quantize the set of LSPs generated by the transform module. For example, the quantizer may include or be coupled to multiple codebooks that include multiple entries (e.g., vectors). To quantize the set of LSPs, the quantizer may identify entries of codebooks that are “closest to” (e.g., based on a distortion measure such as least squares or mean square error) the set of LSPs. The quantizer may output an index value or series of index values corresponding to the location of the identified entries in the codebook. The output of the quantizer may thus represent low-band filter parameters that are included in a low-band bit-stream 242.

The low-band encoder 204 may also generate a low-band excitation signal 244. For example, the low-band excitation signal 244 may be an encoded signal that is generated by quantizing a LP residual signal that is generated during the LP process performed by the low-band encoder 204. The LP residual signal may represent prediction error.

The system 200 may include a seed generator selector 208 that includes a plurality of seed generators, such as the first encoder seed generator 108 and the second encoder seed generator 160 of FIG. 1. The seed generator selector 208 may be configured to select the first encoder seed generator 108 in response to determining that a criterion is satisfied and to select the second encoder seed generator 160 in response to determining that the criterion is not satisfied, such as described with respect to the encoder 114 of FIG. 1.

The system 200 may include an excitation signal generator 222 that includes the noise generator 110 and the bandwidth extension module 118 of FIG. 1 and also includes a modulator 252 and an output circuit 258. The excitation signal generator 222 may be configured to generate a high-band excitation signal 286 by extending a spectrum of the low-band excitation signal 244 into a high-band frequency range (e.g., 8 kHz-16 kHz). To illustrate, the bandwidth extension module 118 may be configured to apply a transform to the low-band excitation signal 244 (e.g., a non-linear transform such as an absolute-value or square operation) to generate an extended low-band excitation signal 262. The noise generator 110 may be configured to generate white noise 260 based on a seed 236 received from the seed generator selector 208. The modulator 252 may be configured to modulate the white noise 260 from the noise generator 110 according to an envelope corresponding to the low-band excitation signal 244 that mimics slow varying temporal characteristics of the low-band signal 234 to generate modulated white noise as the noise signal 138 of FIG. 1. The output circuit 258 may be configured to mix the extended low-band excitation signal 262 with the noise signal 138 to generate the high-band excitation signal 286.

The system 200 may further include a high-band encoder 272 configured to receive the high-band signal 240 from the filter bank 202 and the high-band excitation signal 286 from the excitation signal generator 222. The high-band encoder 272 may generate high-band side information in a high-band bit-stream 290 based on the high-band signal 240 and the high-band excitation signal 286. For example, the high-band bit-stream 290 may include high-band LSPs and/or gain information (e.g., based on at least a ratio of high-band energy to low-band energy), as further described herein.

The high-band excitation signal 286 may be used to determine one or more high-band gain parameters that are included in the high-band side information. The high-band encoder 272 may also include an LP analysis and coding module, a LPC to LSP transform module, and a quantizer. Each of the LP analysis and coding module, the transform module, and the quantizer may function as described above with reference to corresponding components of the low-band encoder 204, but at a comparatively reduced resolution (e.g., using fewer bits for each coefficient, LSP, etc.). The LP analysis and coding module may generate a set of LPCs that are transformed to LSPs by the transform module and quantized by the quantizer based on a codebook. For example, the LP analysis and coding module, the transform module, and the quantizer may use the high-band signal 240 to determine high-band filter information (e.g., high-band LSPs) that is included in the high-band side information. According to one implementation, the high-band side information may include high-band LSPs as well as high-band gain parameters. The high-band encoder 272 may include a local decoder that uses filter coefficients based on the LPCs generated by the transform module and that receives the high-band excitation signal 286 as an input. An output of the synthesis filter of the local decoder (e.g., a synthesized version of the high-band signal 240) may be compared to the high-band signal 240 and gain parameters (e.g., a frame gain and/or temporal envelope gain shaping values) may be determined, quantized, and included in the high-band side information in the high-band bit-stream 290.

The low-band bit-stream 242 and the high-band bit-stream 290 may be multiplexed by a multiplexer (MUX) 274 to generate an output bit-stream 232. The output bit-stream 232 may represent an encoded audio signal corresponding to the audio signal 130. For example, the output bit-stream 232 may be transmitted (e.g., over a wired, wireless, or optical channel) and/or stored. At a receiver, reverse operations may be performed by a demultiplexer (DEMUX), a low-band decoder, a high-band decoder, and a filter bank to generate an audio signal (e.g., a reconstructed version of the audio signal 130 that is provided to a speaker or other output device). The number of bits used to represent the low-band bit-stream 242 may be substantially larger than the number of bits used to represent the high-band bit-stream 290. Thus, most of the bits in the output bit-stream 232 may represent low-band data. The high-band bit-stream 290 may be used at a receiver to regenerate the high-band excitation signal from the low-band data in accordance with a signal model. For example, the signal model may represent an expected set of relationships or correlations between low-band data (e.g., the low-band signal 234) and high-band data (e.g., the high-band signal 240). Thus, different signal models may be used for different kinds of audio data (e.g., speech, music, etc.), and the particular signal model that is in use may be negotiated by a transmitter and a receiver (or defined by an industry standard) prior to communication of encoded audio data. Using the signal model, the high-band encoder 272 at a transmitter may be able to generate the high-band bit-stream 290 such that a corresponding high-band analysis module at a receiver is able to use the signal model to reconstruct the high-band signal 240 from the output bit-stream 232, such as described with respect to FIG. 3.

FIG. 3 is a diagram illustrating a particular example of audio signal decoding components that may be included in one or more devices of the system of FIG. 1, such as in the decoder 116 of the second device 106. The system 300 includes a DEMUX 302 coupled to a low-band synthesizer 304, a seed generator selector 308, and a high-band synthesizer 368. The low-band synthesizer 304 and the seed generator selector 308 may be coupled to the high-band synthesizer 368 via the excitation signal generator 222. The low-band synthesizer 304 and the high-band synthesizer 368 may be coupled to a filter bank 370 (e.g., a synthesis filter bank).

The DEMUX 302 may be configured to receive the bit-stream 232. The DEMUX 302 may generate a low-band portion of bit-stream 332 and a high-band portion of bit-stream 318 from the bit-stream 232. The DEMUX 302 may provide the low-band portion of bit-stream 332 to the low-band synthesizer 304 and the seed generator selector 308. The DEMUX 302 may provide the high-band portion of bit-stream 318 to the high-band synthesizer 368.

The low-band synthesizer 304 may be configured to extract and/or decode one or more bit-stream parameters 342 (e.g., low-band parameter information of the audio signal 130) and a low-band excitation signal 344 (e.g., a low-band residual of the audio signal 130) from the low-band portion of bit-stream 332. The low-band synthesizer 304 may be configured to generate a synthesized low-band signal 334 based on the bit-stream parameters 342 and the low-band excitation signal 344 using a particular low-band model. The low-band synthesizer 304 may provide the synthesized low-band signal 334 to the filter bank 370.

The seed generator selector 308 may be configured to select the first decoder seed generator 158 or the second decoder seed generator 170 based on determining whether an audio frame corresponding to the low-band portion of bit-stream 332 satisfies a criterion, as described with reference to FIG. 1. The selected decoder seed generator (e.g., the first decoder seed generator 158 or the second decoder seed generator 170) may be configured to generate a seed value 336, as described with reference to FIG. 1. The seed generator selector 308 may provide the seed value 336 to the excitation signal generator 222. In a particular implementation, the seed value 336 may correspond to the seed 236 of FIG. 2.

The excitation signal generator 222 may receive the low-band excitation signal 344 from the low-band synthesizer 304 and may receive the seed value 336 from the seed generator selector 308. The excitation signal generator 222 may generate the high-band excitation signal 156 based on the low-band excitation signal 344, the seed value 336, or both, as described with reference to FIGS. 1 and 2. For example, the excitation signal generator 222 may generate white noise based on the seed value 336. The white noise may correspond to the noise signal 168 of FIG. 1. The excitation signal generator 222 may generate the high-band excitation signal 156 based on the white noise, as described with reference to FIG. 2. The high-band excitation signal 156 may correspond to the high-band excitation signal 286 of FIG. 2. The excitation signal generator 222 may provide the high-band excitation signal 156 to the high-band synthesizer 368.

The high-band synthesizer 368 may provide a synthesized high-band signal 388 to the filter bank 370 based on the high-band excitation signal 156 and the high-band portion of bit-stream 318. For example, the high-band synthesizer 368 may extract high-band parameters of the audio signal 130 from the high-band portion of bit-stream 318. The high-band synthesizer 368 may use the high-band parameters and the high-band excitation signal 156 to generate the synthesized high-band signal 388 based on a particular high-band model. In a particular aspect, the filter bank 370 may combine the synthesized low-band signal 334 and the synthesized high-band signal 388 to generate the output signal 128.

Generating a seed value based on a previous seed value may enable a flat distribution of seed values. Generating a seed value based on a bit-stream parameter may enable the decoder to have the same seed value as the encoder. The system 300 may enable a balance between a flat distribution of seed values and having the same seed value at the decoder as the encoder. For example, the system 300 may enable a selection of the first decoder seed generator 158 to generate a seed value based on a bit-stream parameter when a criterion is satisfied and selection of the second decoder seed generator 170 to generate a seed value based on a previous seed value when the criterion is not satisfied.

FIGS. 4A-D are diagrams illustrating particular examples of seed values that may be generated by seed generators of the devices of FIG. 1 for several example sequences of audio frames.

FIGS. 4A-4B depict seed values generated by an encoder (e.g., the first device 104 of FIG. 1) and by a decoder (e.g., the second device 106 of FIG. 1) for each frame of a sequence of frames. The seed values of sequentially later frames are generated based on seed values of sequentially earlier frames. For example, the seed values may correspond to seed values generated according to the second seed generation scheme 171 of FIG. 1, such as an implementation where the seed generator selectors 208 of FIGS. 2 and 308 of FIG. 3 are disabled to prevent selection of the first seed generation scheme 159.

In FIG. 4A, both the encoder and the decoder generate a seed value (SV) 402, which may be a default seed value that is used for a sequentially first frame of a sequence of frames, for a frame having a frame index of 4000 (“frame 4000”). At frame 4001, both the encoder and the decoder generate a seed value 404 based on the seed value 402 of the sequentially prior frame (i.e., frame 4000). As an illustrative, non-limiting example, the seed value 402 may be doubled to generate the seed value 404.

Frame 4002 may be associated with a different coding mode than frames 4000 and 4001. For example, frames 4000 and 4001 may be associated with a first coding mode, such as time domain band width extension (TD-BWE), and frame 4002 may be associated with a second coding mode (e.g., not TD-BWE) that is distinct from the first coding mode and that does not use a seed value. The encoder and the decoder do not generate seed values for frame 4002.

Frames 4003-4005 may be associated with the first coding mode (e.g., TD-BWE). For frame 4003, the encoder and the decoder may generate a seed value 406 based on the seed value of the sequentially prior frame that is associated with the first coding mode, i.e., seed value 404 of frame 4001. The encoder and the decoder may generate a seed value 408 for frame 4004 based on seed value 406 of frame 4003. The encoder and the decoder may generate a seed value 410 for frame 4005 based on seed value 408 of frame 4004.

The seed values generated by the encoder and the decoder stay in sync (i.e., match) in FIG. 4A even though two mode changes occur at frames 4002 and 4003. However, as illustrated in FIG. 4B, if a packet loss causes frame 4003 to not be received at the decoder, synchronization between the encoder seed values and the decoder seed values may be lost.

In FIG. 4B, seed value generation for frames 4000-4002 matches that of FIG. 4A. For frame 4003, the encoder generates the seed value 406 following the mode change back to the first coding mode. The decoder does not receive frame 4003 and does not detect the mode change. As a result, the decoder does not generate a seed value for frame 4003.

Loss of synchronization is demonstrated at frame 4004. The encoder generates the seed value 408 based on the seed value 406 of frame 4003. The decoder receives frame 4004, detects the mode change, and generates the seed value 406 based on the seed value of the sequentially prior frame that is associated with the first coding mode, i.e., seed value 404 of frame 4001. The encoder and decoder remain out of sync at frame 4005, with the encoder generating seed value 410 based on the encoder's seed value 408 of frame 4004, and the decoder generating seed value 408 based on the decoder's seed value 406 of frame 4004.

FIG. 4C illustrates seed generation at the encoder and decoder for the same frame sequence of FIG. 4B (e.g., coding mode switches at frames 4002 and 4003, and loss of frame 4003 at the decoder). In FIG. 4C, seed values are generated by the encoder and the decoder for each frame based on a bit-stream parameter of the frame. For example, the seed values may correspond to seed values generated according to the first seed generation scheme 159 of FIG. 1, such as an implementation where the seed generator selectors 208 of FIGS. 2 and 308 of FIG. 3 are disabled to prevent selection of the second seed generation scheme 171.

In FIG. 4C, both the encoder and the decoder generate a seed value 432 for frame 4000 based on a bit-stream parameter of the frame 4000, such as based on a bit-stream index value (BI) 420. At frame 4001, both the encoder and the decoder generate a seed value 434 based on bit-stream index value 422 of frame 4001. As an illustrative, non-limiting example, the bit-steam index value may include a LSF index, a low-band pitch index, a low-band fixed codebook excitation index, a pitch gain index, a fixed codebook excitation gain index, a high-band LSF index, or a combination thereof.

The encoder and the decoder do not generate seed values for frame 4002. For frame 4003, the encoder generates a seed value 436 based on a bit-stream index value 424 of frame 4003 following the mode change back to the first coding mode. The decoder does not receive frame 4003 and does not detect the mode change. As a result, the decoder does not generate a seed value for frame 4003.

At frame 4004, both the encoder and the decoder generate a seed value 438 based on a bit-stream index value 426 of frame 4004. At frame 4005, both the encoder and the decoder generate a seed value 440 based on a bit-stream index value 428 of frame 4005. The seed values generated by the encoder and the decoder stay in sync (i.e., match) in FIG. 4C even though two mode changes and a packet loss occur at frames 4002-4003.

FIG. 4D illustrates seed generation at the encoder and decoder for a frame sequence that includes the frame sequence of FIGS. 4B and 4C (e.g., coding mode switches at frames 4002 and 4003, and loss of frame 4003 at the decoder). In FIG. 4D, seed values are generated by the encoder and the decoder selecting between the seed generation scheme of FIGS. 4A-B and the seed generation scheme of FIG. 4C. For example, the seed values may correspond to seed values generated according to the first seed generation scheme 159 of FIG. 1 and/or the second generation scheme 171 of FIG. 1, such as an implementation where the seed generator selectors 208 of FIGS. 2 and 308 of FIG. 3 are enabled to enable seed generator selection as described with respect to FIGS. 1-3.

At frames 4000 and 4001, the encoder and the decoder generate seed values according to the second seed generation scheme 171 of FIG. 1. The encoder and the decoder generate the seed value 402 for frame 4000 based on a default seed value and generate the seed value 404 for frame 4001 based on the seed value 402 of frame 4000. The encoder and the decoder do not generate seed values for frame 4002.

At frame 4003, the encoder determines that a criterion is satisfied by detecting that a coding mode switch has occurred and selects the first seed generation scheme 159 of FIG. 1. The encoder generates the seed value 436 based on the bit-stream index value 424. The decoder does not detect the mode switch and does not generate a seed value.

At frame 4004, the encoder determines that the criterion is not satisfied (e.g., no coding mode switch since frame 4003) and selects the second seed generation scheme 171 of FIG. 1. The encoder generates a seed value 442 based on the seed value 436 of frame 4003. The decoder detects the coding mode switch at frame 4004, determines that the criterion is satisfied, and selects the first seed generation scheme 159 of FIG. 1 to generate the seed value 438 based on the bit-stream index value 426.

The encoder and the decoder use the second seed generation scheme 171 of FIG. 1 and remain out of sync until the coding mode changes to the second coding mode, at frame 4010, and returns to the first coding mode, at frame 4011. At frame 4011, both the encoder and the decoder detect that the criterion is satisfied (by detecting the decoding mode change) and select the first seed generation scheme 159 of FIG. 1 to generate a seed value 454 based on a bit-stream index value 456 of frame 4011. At frame 4012, both the encoder and the decoder detect that the criterion is not satisfied (detecting no coding mode change) and select the second seed value generation scheme 171 of FIG. 1 to generate a seed value 468 based on the seed value 454 of frame 4011.

As illustrated in FIG. 4D, seed generation at the encoder and decoder goes out of sync when a lost packet occurs at a coding mode switch (e.g., at the frame 4002-4003 mode switch) and sync is restored after a next coding mode switch (at the frame 4010-4011 mode switch). In other examples, sync may be restored responsive to the encoder and the decoder detecting one or more other events, such as by determining that a first audio frame (e.g., frame 4011) is to be decoded using the random noise generator and that a second frame (e.g., frame 4010) is to be decoded independently of the random noise generator, by determining that a pitch gain of the first audio frame satisfies a threshold pitch gain, by determining that a spectral tilt of the first audio frame satisfies a threshold spectral tilt, or by determining that a voicing parameter of the first audio frame satisfies a threshold voicing parameter.

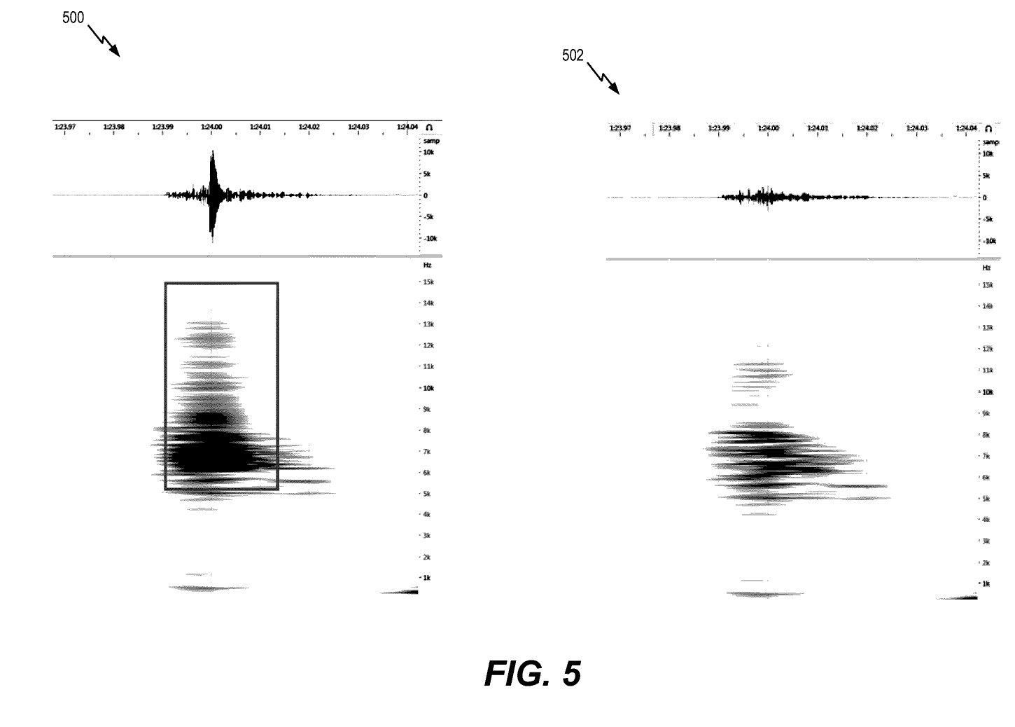

FIG. 5 is a diagram illustrating examples of spectrograms of decoded speech that is generated based on a seed mismatch and that is generated based on a matching seed. A first graph 500 illustrates a spectrogram of the decoded speech and a time domain waveform of the decoded speech generated based on an encoder/decoder seed mismatch at index 1:24.00. A sharp peak appears at 1:24.00 due to mismatch of high-band excitations at the encoder and the decoder, impacting gain parameter calculations and “leakage” between frames. For example, since the high-band excitation is dependent on the seed value, there is a mismatch of this high-band excitation between the encoder and the decoder leading to a mismatch in the synthesized speech that is used as an input for estimation and compensation of gain parameters (frame gain values and sub-frame gain values) for all frames following the first seed value mismatch. The mismatch in the input to sub-frame gain compensation could lead to unwanted signal scaling at the decoder, which leads to audible artifacts. When this mismatch occurs near a frame boundary, the ripple effects can also leak into the next frame.

A second graph 502 illustrates a spectrogram of the decoded speech and a time domain waveform of the decoded speech generated based on an encoder and decoder that operate in accordance with FIGS. 1-3. Although a seed mismatch occurs, sync is quickly restored, avoiding the sharp peak at index 1:24.00 of the first graph 500.

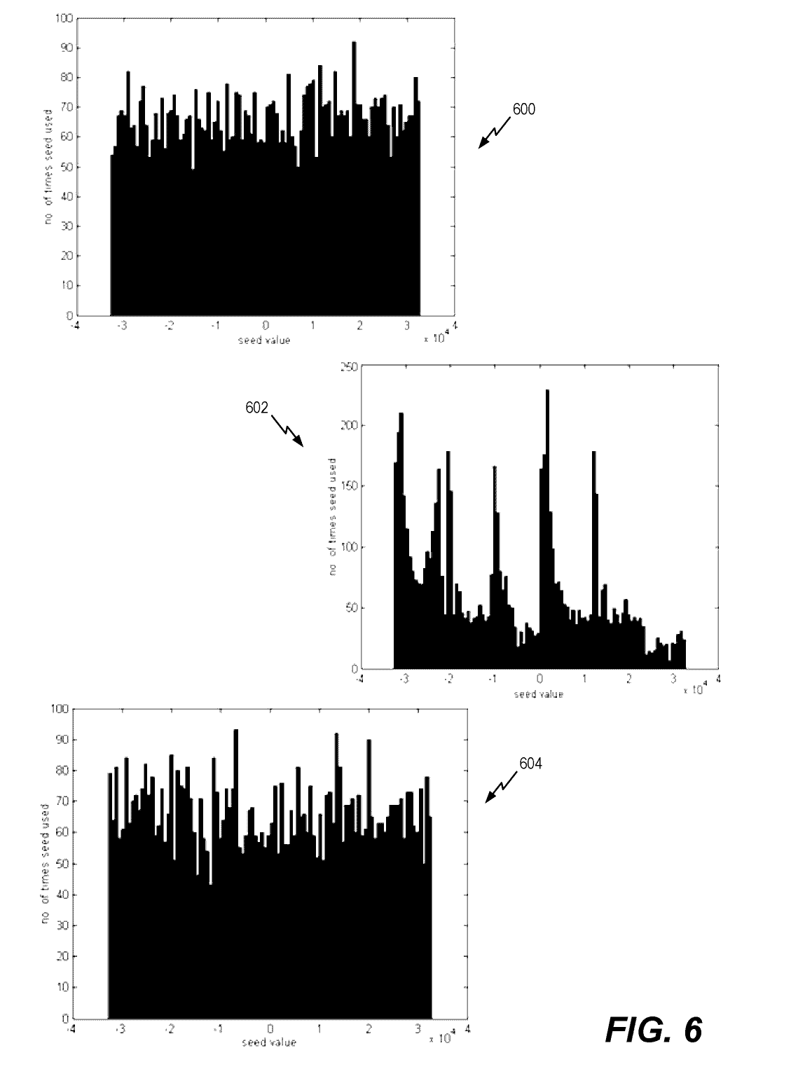

FIG. 6 is a diagram illustrating examples of histograms of seed values generated according to different seed generation schemes that may be used by one or more devices of the system of FIG. 1. A first histogram 600 illustrates a number of times each seed value is used in a system that uses the second seed generation scheme 171 of FIG. 1 (without switching to the first seed generation scheme 159). A second histogram 602 illustrates a number of times each seed value is used in a system that uses the first seed generation scheme 159 of FIG. 1 (without switching to the second seed generation scheme 171). A third histogram 604 illustrates a number of times each seed value is used in a system that selects between using the first seed generation scheme 159 and the second seed generation scheme 171 as described with respect to FIGS. 1-3.

The first histogram 600 depicts seed distribution that is relatively uniform, and the second histogram 602 depicts a relatively non-uniform seed distribution. To illustrate, because bit-stream parameters may span a limited range of values and because an input speech signal may be relatively stationary, some seed values are more likely to be generated than others and multiple consecutive frames may have the same seed value. As a result, randomness in the high-band excitation signal generated based on the seed may be reduced, which may impact audible performance of an audio device.

The third histogram 604 is also relatively uniform because a majority of frames may use the second seed generation scheme 171 rather than the first seed generation scheme 159 of FIG. 1. Thus, the seed generation scheme selection as described with respect to FIGS. 1-3 reduces occurrences of seed non-synchronization while providing a relatively uniform distribution of seed values. In some example embodiments, the seed value may also be generated such that there are no perceptual artifacts associated with the random noise generation.

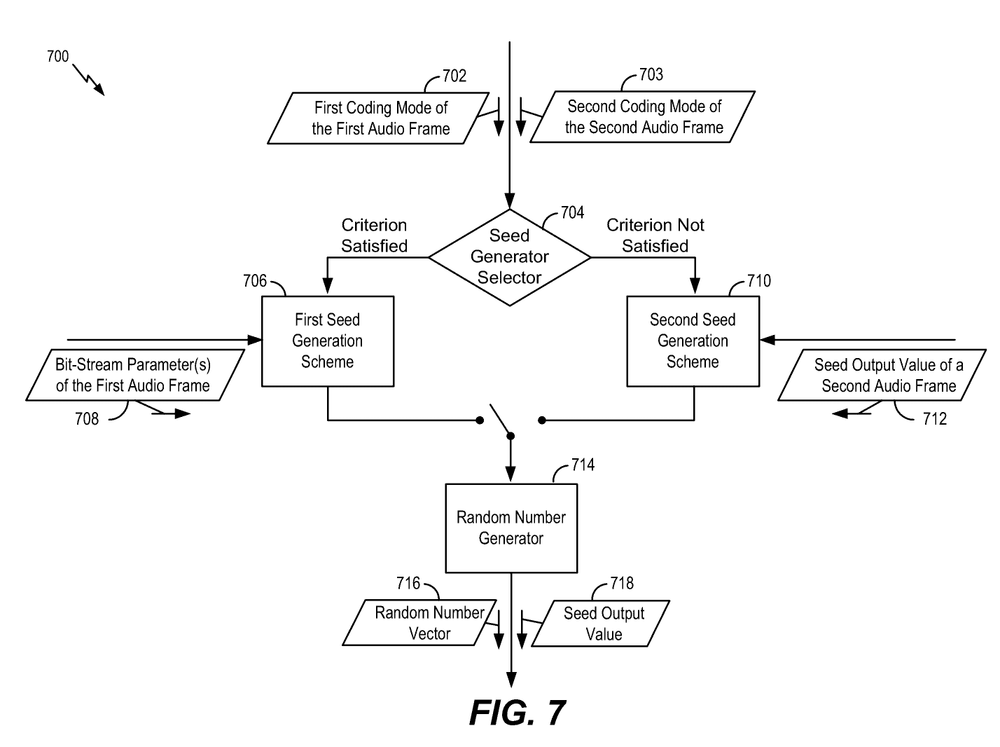

FIG. 7 is a diagram illustrating a particular example of seed generation scheme selection system generally designated 700 with components that may be included in one or more devices of the system of FIG. 1, such as the encoder 114 of the first device 104 or the decoder 116 of the second device 106.

The system 700 includes seed generator selector 704 configured to receive information indicating a first encoding mode 702 that is associated with a first audio frame. The first audio frame may correspond to the frame 136 of FIG. 1. As an illustrative example, a second audio frame precedes the first audio frame in the sequence of frames. The second audio frame may correspond to the frame 134 of FIG. 1. The seed generator selector 704 may also be configured to receive information indicating a second encoding mode 703 that is associated with the second audio frame. The first coding mode 702 may be a non-speech coding mode (e.g., an inactive coding mode or a music coding mode) or a speech coding mode (e.g., an active coding mode). The seed generator selector 704 may select a particular seed generation scheme based on a criterion being satisfied. For example, the criterion may be satisfied when the first coding mode 702 of the first audio frame is different from the second coding mode 703 of the second audio frame. Alternatively, the criterion may not be satisfied when the first coding mode 702 is the same as the second coding mode 703.

As an illustrative example, if the first coding mode is an inactive coding mode and the second coding mode is an active coding mode, the criterion may be satisfied. In response to the criterion being satisfied, the seed generator selector 704 selects a first seed generation scheme 706. The first seed generation scheme 706 is configured to generate a seed value based on at least a portion of a first bit-stream parameter 708 of the first audio frame, as described herein.

As another example, if the first coding mode 702 is a music coding mode and the second coding mode 703 is not a music coding mode (e.g., speech coding mode), the criterion may be satisfied. In response to the criterion being satisfied, the seed generator selector 704 selects the first seed generation scheme 706.

As another example, if the first coding mode 702 is either a music coding mode or an inactive coding mode and the second coding mode 703 is neither a music coding mode nor an inactive coding mode (e.g., distinct from the first coding mode), the criterion may be satisfied. In response to the criterion being satisfied, the seed generator selector 704 selects the first seed generation scheme 706. As a generalization, the criterion may be satisfied when the first coding mode 702 belongs to a first subset of a set of possible coding modes and the second coding mode 703 belongs to a second subset of the set of possible coding modes. The second subset may be a complementary subset of the first subset among the set of possible coding modes.

As another example, if the first coding mode 702 is an active coding mode and the second coding mode 703 is an active coding mode, the criterion is not satisfied. In response to the criterion not being satisfied, the seed generator selector 704 may select a second seed generation scheme 710. The second seed generation scheme 710 is configured to generate a seed value based on a seed output value 712. The seed output value 712 may correspond to output from a random number generator 714 resulting from processing based on the second audio frame.

The random number generator 714 receives the seed value from the first seed generation scheme 706 or the second seed generation scheme 710, depending on which seed generation scheme was selected by the seed generator selector 704. The seed value may be used as a seed input to the random number generator 714. The random number generator 714 is configured to generate a random number vector 716 (e.g., a sequence of random numbers) based on the input to the random number generator 714. The random number generator 714 is also configured to generate a seed output value 718 based on the seed input to the random number generator 714. The seed output value 718 may be the last element of the random number vector 716.

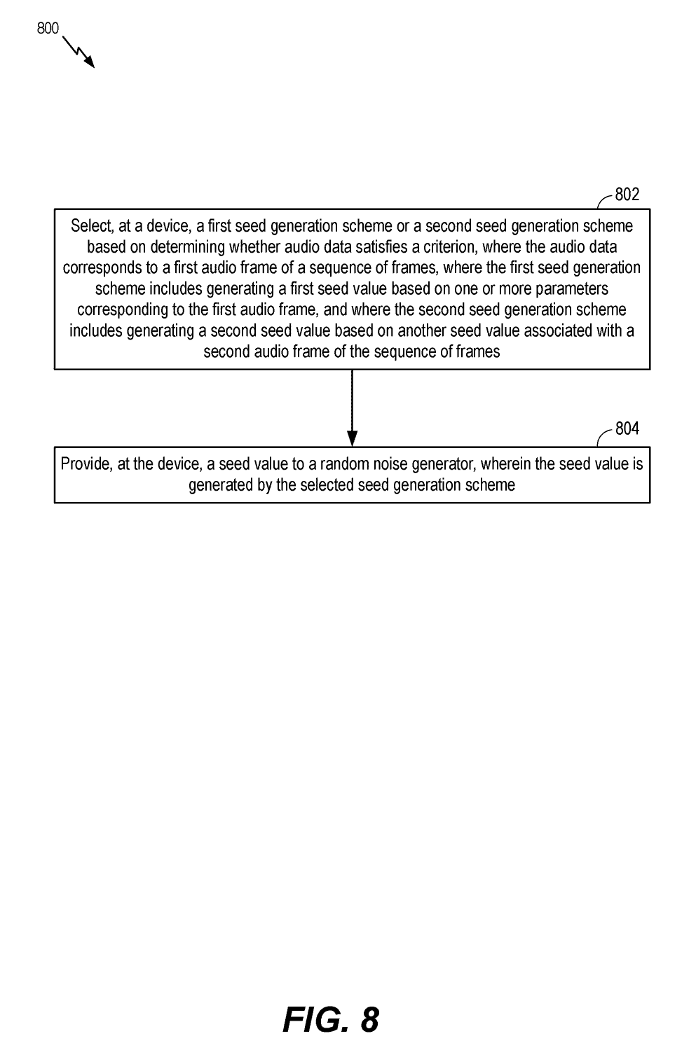

FIG. 8 is a flow chart illustrating a particular method 800 of generating a seed value. In a particular implementation, one or more operations of the method 800 may be executed by at least one of the first device 104 or the second device 106 of FIG. 1.

The method 800 includes selecting, at a device, a first seed generation scheme or a second seed generation scheme based on determining whether audio data satisfies a criterion, at 802. For example, the decoder 116 of the second device 106 may select the first seed generation scheme 159 or the second seed generation scheme 171 based on determining whether the audio data 166 (e.g., the frame 136) satisfies a criterion, as described with reference to FIG. 1. The audio data 166 may correspond to the frame 136.

The decoder 116 may select the first seed generation scheme 159 in response to determining that the audio data 166 (e.g., the frame 136) satisfies the criterion. For example, the decoder 116 may select the first seed generation scheme 159 in response to determining that a first coding mode is associated with the frame 136, that a second coding mode is associated with a second frame (e.g., the frame 132 or the frame 134), and that the first coding mode (e.g., a Time Domain Bandwidth Extension mode) is distinct from the second coding mode. The decoder 116 may select the first seed generation scheme 159 in response to determining that the frame 136 is to be encoded (or decoded) using the noise generator 110 and that the second frame (e.g., the frame 132 or the frame 134) is to be encoded (or decoded) independently of the noise generator 110. The decoder 116 may select the first seed generation scheme 159 in response to determining that the frame 136 is encoded (or decoded) by a first coder, that the second frame (e.g., the frame 132 or the frame 134) is encoded (or decoded) by a second coder, and that the first coder (e.g., an ACELP coder) is distinct from the second coder (e.g., a TCX coder). The decoder 116 may select the first seed generation scheme 159 in response to determining that the frame 136 is associated with a first frame type, that the second frame (e.g., the frame 132 or the frame 134) is associated with a second frame type, and that the first fame type (e.g., speech) is distinct from the second frame type (e.g., non-speech or music).

In a particular implementation, the decoder 116 may select the first seed generation scheme 159 in response to determining that a pitch gain of the frame 136 satisfies a threshold pitch gain, that a spectral tilt of the frame 136 satisfies a threshold spectral tilt, that a voicing parameter of the frame 136 satisfies a threshold voicing parameter, or a combination thereof. The decoder 116 may select the second seed generation scheme 171 based on determining that the audio data 166 (e.g., the frame 136) fails to satisfy the criterion.

The first seed generation scheme 159 may include generating the seed value 184 based on one or more parameters corresponding to a frame, such as the bit-stream parameter 176 corresponding to the frame 136. The bit-stream parameter 176 may include at least a portion of at least one of a low-band LSF index, a low-band pitch index, a low-band fixed codebook excitation index, a pitch gain index, a fixed codebook excitation gain index, or a high-band LSF index. The second seed generation scheme 171 may include generating the seed value 182 based on another seed value (e.g., the seed value 148) associated with a second frame (e.g., the frame 132 or the frame 134). The second frame may precede the frame 136 in a sequence of the frames 132, 134, and 136.

The method 800 also includes providing, at the device, a seed value to a random noise generator, at 804. For example, the decoder 116 may provide the seed value 182 (or the seed value 184) to the noise generator 110. The decoder 116 may store the seed value 182 (or the seed value 184) in the memory 154 of FIG. 1. The noise generator 110 may generate the noise signal 138 based on the seed value 182 (or the seed value 184). The bandwidth extension module 118 may generate the high-band excitation signal 156 based on the noise signal 168 and a low-band excitation signal associated with the frame 136, as described with reference to FIG. 1. For example, the bandwidth extension module 118 may generate a second signal by extending the low-band excitation signal. The bandwidth extension module 118 may generate the high-band excitation signal 156 based on a combination of the second signal and the noise signal 168.

In the particular implementation described by the method 800, the criterion to select between the first and the second seed generation mechanisms is whether the second coding mode of the second audio frame is different from the first coding mode of the first audio frame. As an illustrative example, the first coding mode of the first audio frame may be determined to be a non-speech coding mode (e.g., an inactive coding mode or a music coding mode) and the second coding mode of the second audio frame may be determined to be a speech coding mode (e.g., an active coding mode). In this particular example, the first seed generation scheme is based on seed generation of the bit-stream of the first audio frame (e.g., the bit-stream parameter), while the second seed generation scheme is based on a seed output value generated by processing a random number generator on the second audio frame. For example, the random number generator may be processed on the second audio frame, as described herein, and the random number generator may generate a corresponding seed output value that may be used as a seed input to the second seed generation scheme. The random number generator is configured to generate a random number vector (e.g., a sequence of random numbers) based on the seed input. The random number generator also outputs a seed output value that may be at the end of the random number vector. The seed output value may be used in subsequent random number generation schemes or seed generation schemes, as described herein.

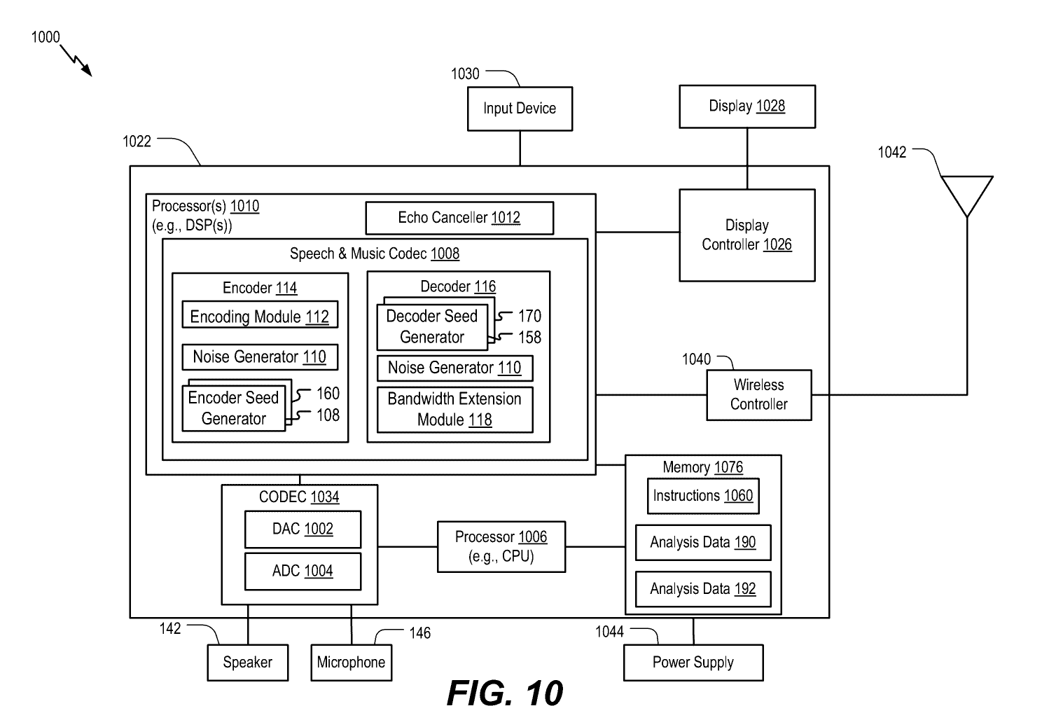

The method 800 of FIG. 8 may be implemented by an FPGA device, an ASIC, a processing unit such as a CPU, a DSP, a controller, another hardware device, firmware device, or any combination thereof. As an example, the method 800 of FIG. 8 may be performed by a processor that executes instructions, as described with respect to FIG. 10.

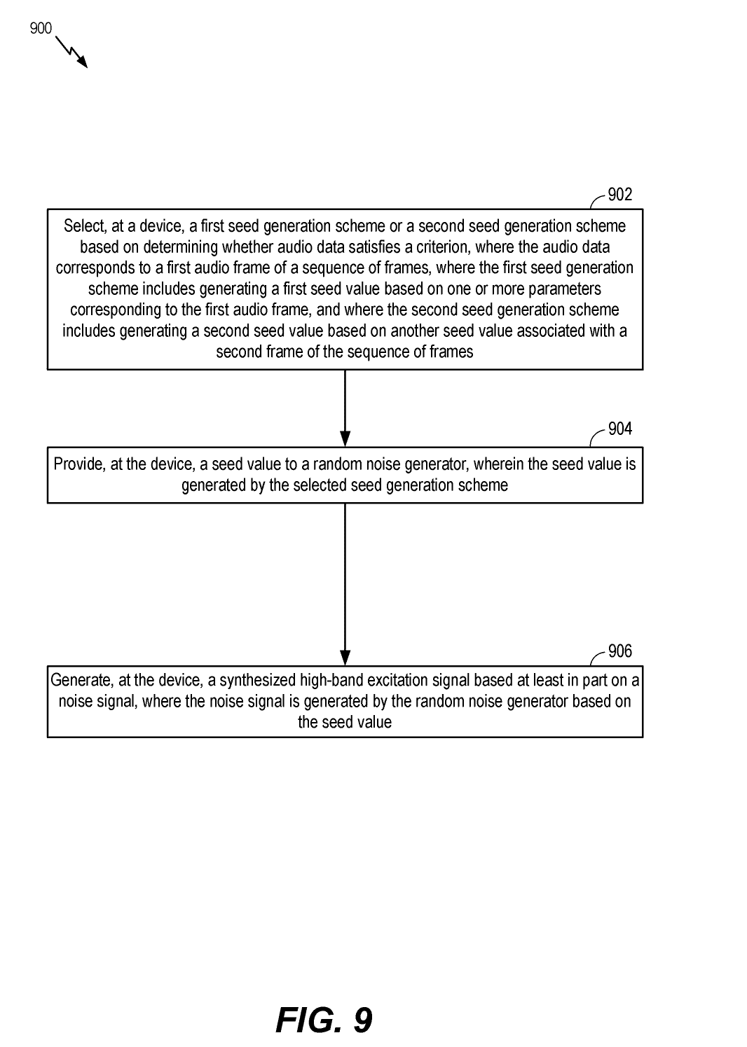

FIG. 9 is a flow chart illustrating another particular method 900 of generating a seed value. In a particular implementation, one or more operations of the method 900 may be executed by at least one of the first device 104 or the second device 106 of FIG. 1.

The method 900 includes selecting, at a device, a first seed generation scheme or a second seed generation scheme based on determining whether audio data satisfies a criterion, at 902, and providing, at the device, a seed value to a random noise generator, at 904, as in the method 800 of FIG. 8. For example, the decoder 116 may provide the seed value 182 (or the seed value 184) to the noise generator 110.

The method 900 further includes generating, at the device, a synthesized high-band excitation signal based at least in part on a noise signal, at 906. For example, the bandwidth extension module 118 may generate the high-band excitation signal 156 based on the noise signal 168, as described with reference to FIGS. 1 and 3. The noise signal 168 may be generated by the noise generator 110 based on the seed value 182 (or the seed value 184).

The method 900 of FIG. 9 may be implemented by an FPGA device, an ASIC, a processing unit such as a CPU, a DSP, a controller, another hardware device, firmware device, or any combination thereof. As an example, the method 900 of FIG. 9 may be performed by a processor that executes instructions, as described with respect to FIG. 10.

FIG. 10 is a block diagram of a particular illustrative example of a device 1000 (e.g., a wireless communication device) that is operable to select between multiple seed generation schemes. In various implementations, the device 1000 may have more or fewer components than illustrated in FIG. 10. In an illustrative aspect, the device 1000 may correspond to the first device 104, the second device 106 of FIG. 1, or both. In an illustrative aspect, the device 1000 may operate according to one or more of the systems or methods described with reference to FIGS. 1-9.

In a particular aspect, the device 1000 includes a processor 1006 (e.g., a CPU). The device 1000 may include one or more additional processors 1010 (e.g., one or more DSPs). The processors 1010 may include a speech and music coder-decoder (CODEC) 1008 and an echo canceller 1012. The speech and music codec 1008 may include the encoder 114 (e.g., a vocoder encoder), the decoder 116 (e.g., a vocoder decoder), or both.

The device 1000 may include a memory 1076 and a CODEC 1034. The memory 1076 may correspond to the memory 144, the memory 154 of FIG. 1, or both. The memory 1076 may include the analysis data 190, the analysis data 192, or both. The device 1000 may include a wireless controller 1040 coupled to an antenna 1042.

The device 1000 may include a display 1028 coupled to a display controller 1026. The speaker 142, the microphone 146, or both, may be coupled to the CODEC 1034. The CODEC 1034 may include a digital-to-analog converter (DAC) 1002 and an analog-to-digital converter (ADC) 1004. In a particular aspect, the CODEC 1034 may receive analog signals from the microphone 146, convert the analog signals to digital signals using the ADC 1004, and provide the digital signals to the speech and music codec 1008. The speech and music codec 1008 may process the digital signals. In a particular aspect, the speech and music codec 1008 may provide digital signals to the CODEC 1034. The CODEC 1034 may convert the digital signals to analog signals using the DAC 1002 and may provide the analog signals to the speaker 142.

The device 1000 may include the encoding module 112, the noise generator 110, the first encoder seed generator 108, the second encoder seed generator 160, the first decoder seed generator 158, the second decoder seed generator 170, the bandwidth extension module 118, or a combination thereof. In a particular aspect, the encoder 114, the decoder 116, the encoding module 112, the noise generator 110, the first encoder seed generator 108, the second encoder seed generator 160, the first decoder seed generator 158, the second decoder seed generator 170, the bandwidth extension module 118, or a combination thereof, may be included in the processor 1006, the processors 1010, the CODEC 1034, the speech and music codec 1008, or a combination thereof.

The encoder 114, the decoder 116, the encoding module 112, the noise generator 110, the first encoder seed generator 108, the second encoder seed generator 160, the first decoder seed generator 158, the second decoder seed generator 170, the bandwidth extension module 118, or a combination thereof, may be used to implement a hardware aspect of random noise seed value generation technique described herein. Alternatively, or in addition, a software aspect (or combined software/hardware aspect) may be implemented. For example, the memory 1076 may include instructions 1060 executable by the processors 1010 or other processing unit of the device 1000 (e.g., the processor 1006, the CODEC 1034, or both). The instructions 1060 may executable to implement operations attributed to the encoder 114, the decoder 116, the encoding module 112, the noise generator 110, the first encoder seed generator 108, the second encoder seed generator 160, the first decoder seed generator 158, the second decoder seed generator 170, the bandwidth extension module 118, the processors 1010, the processor 1006, or a combination thereof.

In a particular aspect, the device 1000 may be included in a system-in-package or system-on-chip device 1022. In a particular aspect, the memory 1076, the processor 1006, the processors 1010, the display controller 1026, the CODEC 1034, and the wireless controller 1040 are included in a system-in-package or system-on-chip device 1022. In a particular aspect, an input device 1030 and a power supply 1044 are coupled to the system-on-chip device 1022. Moreover, in a particular aspect, as illustrated in FIG. 10, the display 1028, the input device 1030, the speaker 142, the microphone 146, the antenna 1042, and the power supply 1044 are external to the system-on-chip device 1022. In a particular aspect, each of the display 1028, the input device 1030, the speaker 142, the microphone 146, the antenna 1042, and the power supply 1044 may be coupled to a component of the system-on-chip device 1022, such as an interface or a controller.

The device 1000 may include a headset, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, or any combination thereof.

In an illustrative aspect, the processors 1010 may be operable to perform all or a portion of the methods or operations described with reference to FIGS. 1-8. For example, the microphone 146 may capture an audio signal corresponding to a user speech signal. The ADC 1004 may convert the captured audio signal from an analog waveform into a digital waveform comprised of digital audio samples. The processors 1010 may process the digital audio samples. A gain adjuster may adjust the digital audio samples. The echo canceller 1012 may reduce any echo that may have been created by an output of the speaker 142 entering the microphone 146.

The encoder 114 may compress digital audio samples corresponding to the processed speech signal and may form a sequence of packets (e.g., a representation of the compressed bits of the digital audio samples). The sequence of packets may be stored in the memory 1076. One or more packets of the sequence may include bit-stream parameters. A transceiver may modulate some form of each packet (e.g., other information may be appended to the packet) of the sequence and may transmit the modulated data via the antenna 1042.

As a further example, the antenna 1042 may receive incoming packets corresponding to a sequence of packets sent by another device via a network. The received packets may correspond to a sequence of frames of a user speech signal. The decoder 116 may select the first seed generation scheme 159 or the second seed generation scheme 172 based on determining whether an audio frame satisfies a criterion. The decoder 116 may provide a seed value generated by the selected seed generation scheme to the noise generator 110. The noise generator 110 may generate the noise signal 168 based on the seed value. The bandwidth extension module 118 may generate the output signal 128 based on the noise signal 168.

The echo canceller 1012 may remove echo from the output signal 128. A gain adjuster may amplify or suppress the output signal 128. The DAC 1002 may convert the output signal 128 from a digital waveform to an analog waveform and may provide the output signal 128 to the speaker 142.

In conjunction with the described aspects, an apparatus may include means for generating a synthesized high-band excitation signal. For example, the means for generating may include the decoder 116 of FIG. 1, one or more other devices, circuits, modules, or instructions configured to generate a synthesized high-band excitation signal, or a combination thereof. The means for generating may be configured to select the first decoder seed generator 158 or the second decoder seed generator 170 based on determining whether audio data satisfies a criterion. The means for generating may also be configured to provide a seed value to the noise generator 110. The seed value may be generated by the selected seed generator (e.g., the first seed decoder seed generator 158 or the second decoder seed generator 170). The noise signal 168 may be generated by the noise generator 110 based on the seed value. The synthesized high-band excitation signal (e.g., the high-band excitation signal 156 of FIG. 1) may be generated based at least in part on the noise signal 168.

The apparatus may also include means for storing the synthesized high-band excitation signal. For example, the means for storing may include the memory 154, the memory 1076, or both.

Those of skill would further appreciate that the various illustrative logical blocks, configurations, modules, circuits, and algorithm steps described in connection with the aspects disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein and is to be accorded the widest scope possible consistent with the principles and novel features as defined by the following claims.

What is claimed is:

1. A method comprising:
selecting, at a device, a first seed generation scheme or a second seed generation scheme based on determining whether audio data satisfies a criterion,
wherein the audio data corresponds to a first audio frame of a sequence of frames,
wherein the first seed generation scheme includes generating a first seed value based on one or more parameters corresponding to the first audio frame, and
wherein the second seed generation scheme includes generating a second seed value based on a seed output value associated with a second audio frame of the sequence of frames; and
providing, at the device, a seed value to a random noise generator, wherein the seed value is generated by the selected seed generation scheme.

2. The method of claim 1, wherein the first seed generation scheme is selected in response to determining that the audio data satisfies the criterion, and wherein the second seed generation scheme is selected in response to determining that the audio data fails to satisfy the criterion.

3. The method of claim 1, further comprising determining whether the audio data corresponding to the first audio frame satisfies the criterion by determining whether a first coding mode associated with the first audio frame is different from a second coding mode associated with the second audio frame.

4. The method of claim 1, further comprising determining whether the audio data corresponding to the first audio frame satisfies the criterion by:
determining whether a first coding mode associated with the first audio frame is included in a first subset of a set of possible coding modes; and
determining whether a second coding mode associated with the second audio frame is included in a second subset of the set of possible coding modes, wherein the second subset is the complementary subset of the first subset of the set of possible coding modes.

5. The method of claim 1, wherein the second audio frame precedes the first audio frame in the sequence of frames.

6. The method of claim 1, wherein the one or more parameters include a bit-stream parameter corresponding to the first audio frame.

7. The method of claim 6, wherein the bit-stream parameter includes at least a portion of at least one of a low-band line spectral frequencies (LSF) index, a low-band pitch index, a low-band fixed codebook excitation index, a pitch gain index, a fixed codebook excitation gain index, or a high-band LSF index.

8. The method of claim 1, further comprising generating, at the device, an excitation signal based at least in part on a noise signal, wherein the noise signal is generated by the random noise generator based on the seed value.

9. The method of claim 8, further comprising generating a second signal by extending a low-band excitation signal that is associated with the first audio frame, wherein the excitation signal is generated based on a combination of the noise signal with the second signal.

10. The method of claim 1, further comprising determining that the audio data satisfies the criterion in response to determining that the first audio frame is to be encoded/decoded using the random noise generator and that the second audio frame is to be encoded/decoded independently of the random noise generator.

11. The method of claim 1, further comprising determining whether the audio data satisfies the criterion based on determining whether the first frame uses an inactive coding mode and the second audio frame uses an active coding mode, determining whether the first frame uses a music coding mode and the second audio frame uses a non-music coding mode, or both.

12. The method of claim 1, further comprising determining whether the audio data satisfies the criterion based on determining that the first frame uses either an inactive coding mode or a music coding mode and the second audio frame uses a coding mode which is neither an inactive coding mode nor a music coding mode.

13. The method of claim 1, wherein the random noise generator comprises a random number generator.

14. A device comprising:
a plurality of seed generators;
a processor configured to:
select a particular seed generator of the plurality of seed generators based on determining whether audio data satisfies a criterion; and
provide a seed value to a random noise generator, wherein the seed value is generated by the particular seed generator; and
a memory configured to store the seed value.

15. The device of claim 14, wherein the processor is further configured to generate a synthesized high-band excitation signal based at least in part on a noise signal, wherein the noise signal is generated by the random noise generator based on the seed value.

16. The device of claim 15, wherein the processor is further configured to generate a second signal based on a low-band excitation signal associated with the audio data, and wherein the synthesized high-band excitation signal is generated by combining the noise signal with the second signal.

17. The device of claim 14, wherein the plurality of seed generators includes a first seed generator configured to generate a first seed value based on a bit-stream parameter corresponding to the audio data.

18. The device of claim 17, wherein the processor is configured to select the first seed generator in response to determining that the audio data satisfies the criterion.

19. The device of claim 17, wherein the bit-stream parameter includes at least a portion of at least one of a low-band line spectral frequencies (LSF) index, a low-band pitch index, a low-band fixed codebook excitation index, a pitch gain index, a fixed codebook excitation gain index, or a high-band LSF index.

20. The device of claim 14, wherein the audio data corresponds to a first audio frame, wherein the plurality of seed generators includes a second seed generator configured to generate a second seed value based on a seed output value of a frame that precedes the first audio frame in a sequence of frames, and wherein the processor is configured to select the second seed generator in response to determining that the audio data fails to satisfy the criterion.

21. The device of claim 14, wherein the audio data corresponds to a first audio frame, wherein the processor is configured to determine that the audio data satisfies the criterion in response to determining that the first audio frame is encoded by a first coder and that a frame that precedes the first audio frame in a sequence of frames is encoded by a second coder that is distinct from the first coder.

22. The device of claim 21, wherein the first coder includes an algebraic code-excited linear prediction (ACELP) coder and wherein the second coder includes a transform coded excitation (TCX) coder.

23. The device of claim 14, wherein the audio data corresponds to a first audio frame, wherein the processor is configured to determine that the audio data satisfies the criterion in response to determining that the first audio frame has a first frame type and that a particular frame that precedes the first audio frame in a sequence of frames has a second frame type that is distinct from the first frame type.

24. The device of claim 23, wherein the first frame type corresponds to speech and the second frame type corresponds to music.

25. The device of claim 23, wherein the first frame type corresponds to speech and the second frame type corresponds to non-speech.

26. A computer-readable storage device storing instructions that, when executed by a processor, cause the processor to perform operations comprising:
selecting a particular seed generator of a plurality of seed generators based on determining whether audio data satisfies a criterion;
providing a seed value to a random noise generator, wherein the seed value is generated by the particular seed generator; and
generating a synthesized high-band excitation signal based on a noise signal, wherein the noise signal is generated by the random noise generator based on the seed value.

27. The computer-readable storage device of claim 26, wherein the plurality of seed generators includes a first seed generator configured to generate a first seed value based on a bit-stream parameter corresponding to the audio data, wherein the first seed generator is selected in response to determining that the audio data satisfies the criterion, and wherein the bit-stream parameter includes at least a portion of at least one of a low-band line spectral frequencies (LSF) index, a low-band pitch index, a low-band fixed codebook excitation index, a pitch gain index, a fixed codebook excitation gain index, or a high-band LSF index.

28. The computer-readable storage device of claim 26, wherein the audio data corresponds to a first audio frame, wherein the plurality of seed generators includes a second seed generator configured to generate a second seed value based on a seed output value of a frame that precedes the first audio frame in a sequence of frames, and wherein the second seed generator is selected in response to determining that the audio data fails to satisfy the criterion.

29. An apparatus comprising:
means for generating a synthesized high-band excitation signal configured to select a particular seed generator of a plurality of seed generators based on determining whether audio data satisfies a criterion and to provide a seed value to a random noise generator, wherein the seed value is generated by the particular seed generator, wherein a noise signal is generated by the random noise generator based on the seed value, and wherein the synthesized high-band excitation signal is generated based at least in part on the noise signal; and
means for storing the synthesized high-band excitation signal.

30. The apparatus of claim 29, wherein the means for generating and the means for storing are integrated into at least one of a communications device, a music player, a video player, an entertainment unit, a navigation device, a personal digital assistant (PDA), a mobile device, a computer, a decoder, or a set top box.
